(19) United States
(12) Patent Application Publication
(10) Pub. No.: US 2013/0129544 A1
(43) Pub. Date: May 23, 2013

(54) BARBECUE SMOKER AIR BLOWER AND THE METHOD OF INSTALLATION

(71) Applicant: Suyi Liu, Alpharetta, GA (US)

(72) Inventor: Suyi Liu, Alpharetta, GA (US)

(73) Assignee: AUBER INSTRUMENTS, INC., Alpharetta, GA (US)

(21) Appl. No.: 13/301,303

(22) Filed: Nov. 21, 2011

(51) Int. Cl. A23B 4/044; B23P 11/00; B23P 19/00; F04D 29/00

(52) U.S. Cl. 417/423.15; 126/15 A; 417/423.14; 29/428; 29/426.1

(57) ABSTRACT

An air blower installed on a barbeque smoker, including: (a) a rotary air blowing fan having an air outlet, (b) an air blower body having a first end and a second end with an air passage inside the air blower body between the first end and the second end, (c) a front installation panel, (d) a torsion spring having two arms with a round ring on each of the two arms, (e) a torsion spring retention pin, and (f) a shutter. When the rotary air blowing fan is turned on, the rotary air blowing fan blows air into the air blower body, through the shutter. When the rotary air blowing fan is turned off, the shutter close the air passage by its gravity. The torsion spring can be in the shape of a “V” or a “V” with two arms bent inward so they are approximately parallel.

### FIELD OF THE PRESENT INVENTION

The present invention relates to a barbeque smoker, and more particularly to a barbeque smoker blower mounted on the barbeque smoker, and its method of mounting the barbeque smoker blower on the barbeque smoker.

### BACKGROUND OF THE PRESENT INVENTION

For low temperature cooking in a barbeque smoker, the temperature accuracy and stability play a very important role for the quality of cooking If the temperature is too high, the fat will melt and drip out, causing a dry texture of meat. If the temperature is too low, the food will not be fully cooked on time or stays raw. In order to stabilize the temperature at the desired level, an air blower with a Proportional Integral Derivative controller (PID controller) has been used to control the oxygen by controlling the air flow into the barbeque smoker, which in turn will control the temperature of the barbeque smoker.

Mounting the blower has been a challenge to many blower manufactures. The key to popular acceptance of the air blower is the conveniently installing and uninstalling the air blower. The air blower should be easily installed and removed. When the fire is started, the air blower is not needed to allow maximum air flow to the fire. When the initial cooking reach a predetermined temperature, and the smoker is hot, and the cooking enters a steady cooking stage, the air blower is needed to maintain a steady cooking temperature. Therefore, the air blower can not be permanently installed on the barbeque smoker and it is installed during the barbeque cooking process. Thus, the convenience of its installation and uninstallation is an important feature of the air blower. Additionally, there are many types of barbeque smoker on the market and their vent holes, where the air blower is installed, vary in size and shape dramatically among different manufactures and models. There is no standard venting hole design. The small production quantity and complicated adaptor design significantly increase the cost of the adaptor. The current product on the market are complicated to use and expensive to produce. For example, some use tube type adaptor that has to be preinstalled to the venting hole from the inside of the smoker with a second special mating adaptor can be slide on. Other uses an adaptor which is installed from outside. However, it is not stable and need a lot of practice to install properly while the smoker is hot. It is rather difficult to install and uninstall, the it may be hazardous to the users.

Therefore, a heretofore unaddressed need exists in the art and it is desirable to design an air blower that can be easily installed and/or uninstalled to address the aforementioned deficiencies and inadequacies.

### SUMMARY OF THE PRESENT INVENTION

In one aspect, the present invention relates to an air blower installed on a barbeque smoker having a side wall, and an air inlet opening with side edge. The air blower has: (a) a rotary air blowing fan, (b) an air blower body, (c) a front installation panel, (d) a torsion spring, (e) a torsion spring retention pin, and (f) a shutter. In one embodiment, the rotary air blowing fan has an air outlet. The air blower body has a first end and a second end with an air passage inside the air blower body between the first end and the second end. The front installation panel is used to mount the air blower to the barbeque smoker. The torsion spring has two arms extending to outward. Each of the arms of the torsion spring has a round ring at its end for easy uninstallation. The torsion spring retention pin is used to install the torsion spring onto the air blower body. When the rotary air blowing fan is turned on, the rotary air blowing fan blows air into the air blower body, through the shutter. When the rotary air blowing fan is turned off, the shutter close the air passage by its gravity.

In one embodiment, the air blower further has a shutter retention pin to hold the shutter in place. The air blower is installed onto the side wall of the barbeque smoker with the front installation panel of air blower covering the air inlet opening and the air passage passing through the air inlet opening of the barbeque smoker. The rotary air blowing fan is installed on the second end of the air blower body with the air outlet covering the air passage of the air blower body. In one embodiment, the torsion spring retention pin is installed on the air blower body such that the torsion spring is retained on the torsion spring retention pin. In one embodiment, the torsion spring is in the shape of a “V”. In another embodiment, the torsion spring is in the shape of a “V” with two arms bent inward such that the two arms are approximately parallel for the outer half of the two arms.

When needed, the air blower is installed onto the barbeque smoker side wall by compressing the two arms of the torsion spring to let the two arms to pass through the air inlet opening of the barbeque smoker, and release the two arms of the torsion spring inside of the air inlet opening of the barbeque smoker, such that the two arms expand and pressing on the side edge of the air inlet opening of the barbeque smoker and the resilient force of the two arms of the torsion spring keeps the air blower in place.

In another aspect, the present invention relates to a method of installing an air blower on a barbeque smoker having a side wall, and an air inlet opening with side edge. The method of installing an air blower on a barbeque smoker includes the steps of: (a) providing an air blower, (b) installing the torsion spring onto the torsion spring retention pin on the air blower body, and (c) installing the air blower onto the barbeque smoker through the air inlet opening of the barbeque smoker. In one embodiment, the air blower has: (a) a rotary air blowing fan, (b) an air blower body, (c) a front installation panel, (d) a torsion spring, (e) a torsion spring retention pin, and (f) a shutter. In one embodiment, the rotary air blowing fan has an air outlet. The air blower body has a first end and a second end with an air passage inside the air blower body between the first end and the second end. The front installation panel is used to mount the air blower to the barbeque smoker. The torsion spring has two arms extending to outward. Each of the arms of the torsion spring has a round ring at its end for easy uninstallation. The torsion spring retention pin is used to install the torsion spring onto the air blower body. The air blower also has a shutter retention pin to hold the shutter in place.

In one embodiment, the air blower is installed onto the side wall of the barbeque smoker with the front installation panel of air blower covering the air inlet opening and the air passage passing through the air inlet opening of the barbeque smoker. The rotary air blowing fan is installed on the second end of the air blower body with the air outlet covering the air passage of the air blower body. The torsion spring retention pin is installed on the air blower body such that the torsion spring is retained on the torsion spring retention pin. In one embodiment, the torsion spring is in the shape of a “V”. In another embodiment, the torsion spring is in the shape of a “V” with two arms bent inward such that the two arms are approximately parallel for the outer half of the two arms.

The step of installing the air blower onto the barbeque smoker through the air inlet opening of the barbeque smoker further includes the steps of:
(a) compressing the two arms of the torsion spring;
(b) passing the two compressed arms of the torsion spring through the air inlet opening of the barbeque smoker; and
(c) release the two arms of the torsion spring inside of the air inlet opening of the barbeque smoker, such that the two arms expand and pressing on the side edge of the air inlet opening of the barbeque smoker and the resilient force of the two arms of the torsion spring keep the air blower in place.

In yet another aspect, the present invention relates to a method of uninstalling an air blower from a barbeque smoker having an air inlet opening. The method includes the step of removing the air blower by pulling the air blower out of the air inlet opening of the barbeque smoker.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a perspective view of an assembled air blower 100 for a barbeque smoker according to one embodiment of the present invention;

FIG. 2 is an exploded perspective view of an air blower 100 for a barbeque smoker according to one embodiment of the present invention;

FIG. 3 is a top sectional view of an air blower 100 for a barbeque smoker according to one embodiment of the present invention; and

FIG. 4 is a top sectional view of an air blower 200 for a barbeque smoker according to another embodiment of the present invention.

### DETAILED DESCRIPTION OF THE PRESENT INVENTION

Prior to a detailed description of the present invention(s), the following definitions are provided as an aid to understanding the subject matter and terminology of aspects of the present invention(s), and not necessarily limiting of the present invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

Embodiments of the present invention are described below with reference to the accompanying drawings, and in the accompanying drawings like reference numerals represent like elements.

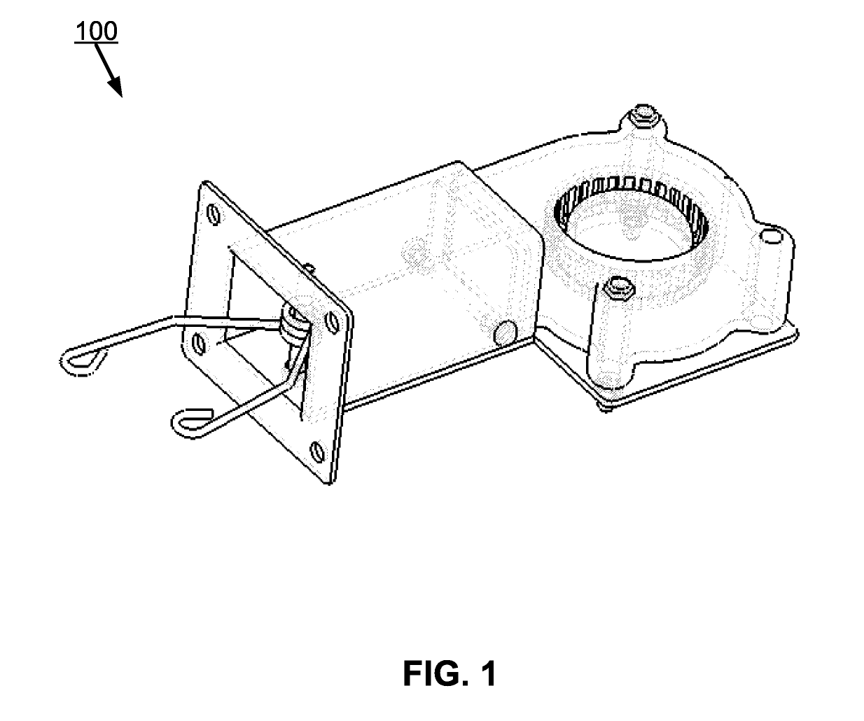

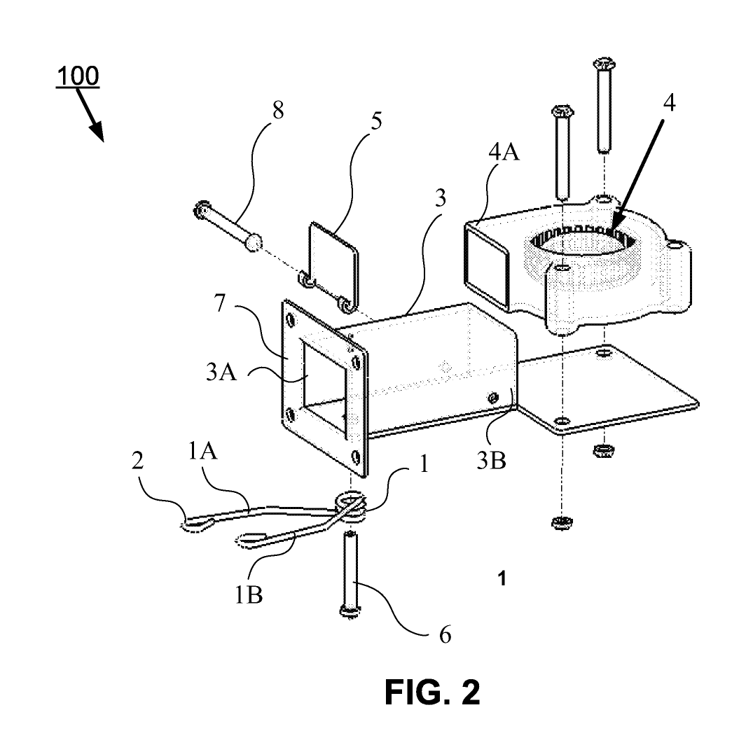

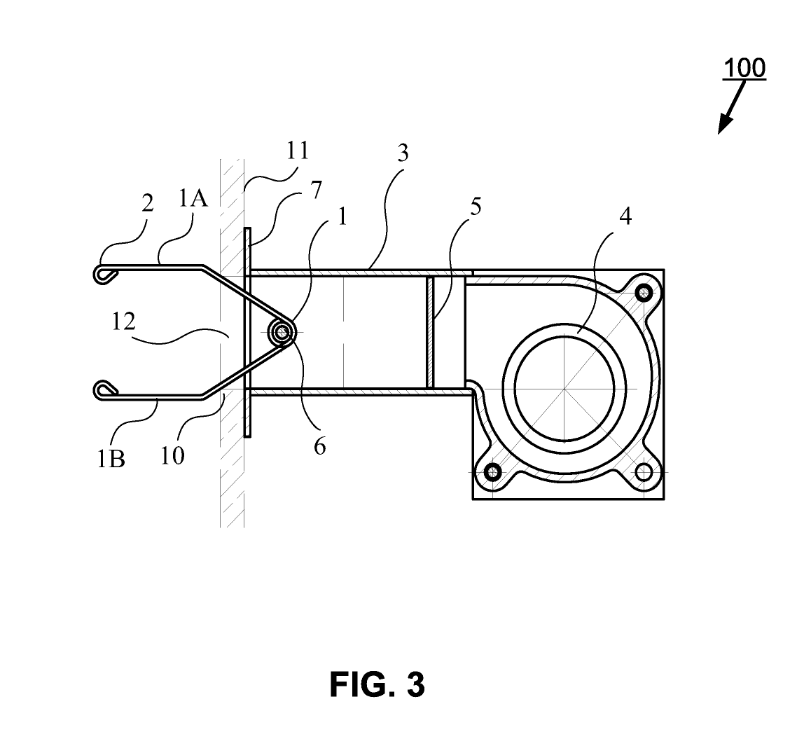

In FIG. 1, a perspective view of an assembled air blower 100 for a barbeque smoker is shown according to one embodiment of the present invention. In FIG. 2, an exploded perspective view of the air blower 100 for a barbeque smoker is shown according to one embodiment of the present invention. FIG. 3 shows a top sectional view of the air blower 100 for a barbeque smoker.

In one aspect, the present invention relates to an air blower 100 as shown in FIG. 2 and FIG. 3. The air blower 100 is used on a barbeque smoker. The barbeque smoker has a side wall 11, and an air inlet opening 12 with side edge 10. In one embodiment, the air blower 100 has: (a) a rotary air blowing fan 4, (b) an air blower body 3, (c) a torsion spring 1, (d) a front installation panel 7, (e) a torsion spring retention pin 6, and (f) a shutter 5. The rotary air blowing fan 4 has an air outlet 4A at one end to provide air flow to the air blower 100. The air blower body 3 has a first end 3A and a second end 3B. There is an air passage inside the air blower body 3 between the first end 3A and the second end 3B. The front installation panel 7 is used to install the air blower 100 to the barbeque smoker. The torsion spring 1 has two arms 1A and 1B. There is a round ring 2 on each of the two arms 1A and 1B. The torsion spring retention pin 6 is installed on the air blower body 3 such that the torsion spring 1 is retained on the torsion spring retention pin 6. The air blower 100 is installed on the barbeque smoker by using the resilient force of the torsion spring 6 to press on the side edge 10 of the air inlet opening 12 of the barbeque smoker.

In one embodiment, the air blower 100 further includes a shutter retention pin 8 to hold the shutter 5 in place. When the rotary air blowing fan 4 is turned on, the rotary air blowing fan 4 blows air into the air blower body 3, through the shutter 5. When the rotary air blowing fan 4 is turned off, the shutter 5 close the air passage by its gravity. The rotary air blowing fan 4 is installed on the second end 3B of the air blower body 3 with the air outlet 4A covering the air passage of the air blower body 3. The air blower 100 is installed onto the side wall 11 of the barbeque smoker with the front installation panel 7 of air blower 100 covering the air inlet opening 12 and the air passage passing through the air inlet opening 12 of the barbeque smoker.

In one embodiment, when needed, the air blower 100 is installed onto the barbeque smoker side wall 11 by compressing the two arms 1A and 1B of the torsion spring 1 to let the two arms 1A and 1B to pass through the air inlet opening 12 of the barbeque smoker, and then release the two arms 1A and 1B of the torsion spring 1 inside of the air inlet 12 of the barbeque smoker, such that the two arms 1A and 1B expand and pressing on the side edge 10 of the air inlet 12 of the barbeque smoker and the resilient force of the two arms 1A and 1B of the torsion spring 1 keep the air blower 100 in place. In one embodiment, the torsion spring is in the shape of a “V” with two arms bent inward such that the two arms are approximately parallel for the outer half of the two arms.

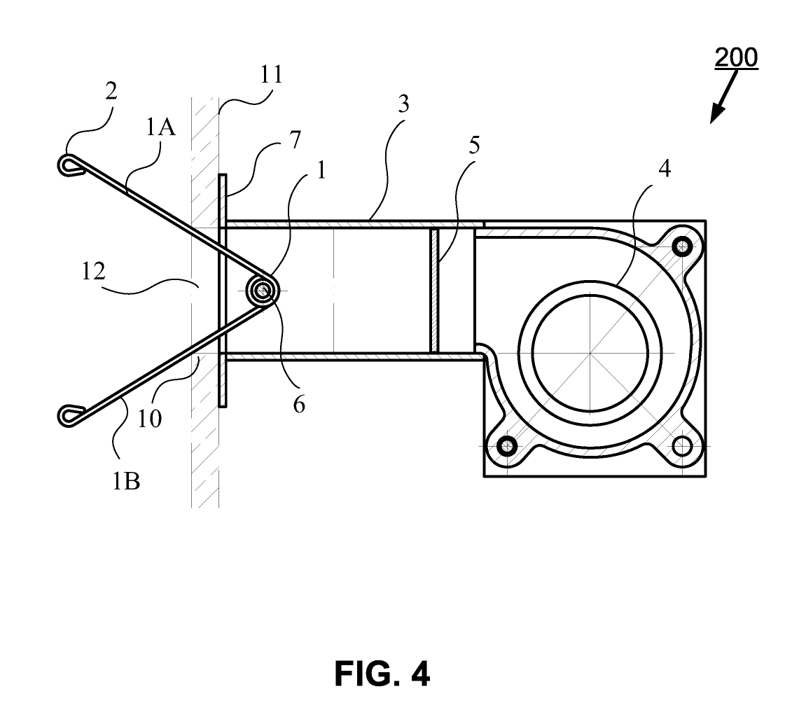

In another embodiment, as shown in FIG. 4, a top sectional view of another embodiment of air blower 200 for a barbeque smoker is shown according to another embodiment of the present invention. In this embodiment, the torsion spring is in the shape of a “V”.

In another aspect, the present invention relates to a method of installing an air blower 100 on a barbeque smoker. The barbeque smoker usually includes a side wall 11, and an air inlet opening 12 with side edge 10. The method includes the steps of:
(a) providing an air blower 100;
(b) installing the torsion spring 1 onto the torsion spring retention pin 6 on the air blower body 3; and
(c) installing the air blower 100 onto the barbeque smoker through the air inlet opening 12 of the barbeque smoker.

In one embodiment, the air blower 100 has: (a) a rotary air blowing fan 4, (b) an air blower body 3, (c) a torsion spring 1, (d) a front installation panel 7, (e) a torsion spring retention pin 6, and (f) a shutter 5. The rotary air blowing fan 4 has an air outlet 4A at one end to provide air flow to the air blower 100. The air blower body 3 has a first end 3A and a second end 3B. There is an air passage inside the air blower body 3 between the first end 3A and the second end 3B. The front installation panel 7 is used to install the air blower 100 to the barbeque smoker. The torsion spring 1 has two arms 1A and 1B. There is a round ring 2 on each of the two arms 1A and 1B. The torsion spring retention pin 6 is installed on the air blower body 3 such that the torsion spring 1 is retained on the torsion spring retention pin 6. The air blower 100 is installed on the barbeque smoker by using the resilient force of the torsion spring 6 to press on the side edge 10 of the air inlet opening 12 of the barbeque smoker.

In one embodiment, the air blower 100 further includes a shutter retention pin 8 to hold the shutter 5 in place. When the rotary air blowing fan 4 is turned on, the rotary air blowing fan 4 blows air into the air blower body 3, through the shutter 5. When the rotary air blowing fan 4 is turned off, the shutter 5 close the air passage by its gravity. The rotary air blowing fan 4 is installed on the second end 3B of the air blower body 3 with the air outlet 4A covering the air passage of the air blower body 3. The air blower 100 is installed onto the side wall 11 of the barbeque smoker with the front installation panel 7 of air blower 100 covering the air inlet opening 12 and the air passage passing through the air inlet opening 12 of the barbeque smoker.

In one embodiment, the step of installing the air blower 100 onto the barbeque smoker through the air inlet opening 12 of the barbeque smoker further includes the steps of:
(a) compressing the two arms 1A and 1B of the torsion spring 1;
(b) passing the two compressed arms 1A and 1B of the torsion spring 1 through the air inlet opening 12 of the barbeque smoker; and
(c) release the two arms 1A and 1B of the torsion spring 1 inside of the air inlet 12 of the barbeque smoker, such that the two arms 1A and 1B expand and press on the side edge 10 of the air inlet 12 of the barbeque smoker and the resilient force of the two arms 1A and 1B of the torsion spring 1 keep the air blower 100 in place.

In yet another aspect, the present invention relates to a method of uninstalling an air blower 100 from a barbeque smoker. The barbeque smoker has a side wall 11, and an air inlet opening 12 with side edge 10. The method of uninstalling an air blower 100 from a barbeque smoker includes the step of removing the air blower 100 by pulling the air blower 100 out of the air inlet opening 12 of the barbeque smoker.

The torsion spring 1 is designed so that the two arms 1A and 1B of the torsion spring 1 creates an expansion force at the air inlet 12 of the barbeque smoker. By selecting the torsion spring 1 with proper tension, the blower can be easily mounted into the vent by simply press the two arms 1A and 1B of the torsion spring 1 together, insert the tips of the torsion spring 1 and release the torsion spring 1. This can be done easily with one hand while the smoker is hot. The spring has rounded ring at the tips to make it safe during handling. The ring is formed in the direction that when pulling the spring out of the vent, it will not catch the vent.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

What is claimed is:

1. An air blower installed on a barbeque smoker having a side wall, and an air inlet opening with side edge, comprising:
(a) a rotary air blowing fan having an air outlet;
(b) an air blower body having a first end and a second end with an air passage inside the air blower body between the first end and the second end;
(c) a front installation panel;
(d) a torsion spring having two arms with a round ring on each of the two arms;
(e) a torsion spring retention pin; and
(f) a shutter,
wherein when the rotary air blowing fan is turned on, the rotary air blowing fan blows air into the air blower body, through the shutter, and when the rotary air blowing fan is turned off, the shutter close the air passage by its gravity.

2. The air blower according to claim 1, wherein the air blower further comprises a shutter retention pin to hold the shutter in place.

3. The air blower according to claim 2, wherein the air blower is installed onto the side wall of the barbeque smoker with the front installation panel of air blower covering the air inlet opening and the air passage passing through the air inlet opening of the barbeque smoker.

4. The air blower according to claim 3, wherein the rotary air blowing fan is installed on the second end of the air blower body with the air outlet covering the air passage of the air blower body.

5. The air blower according to claim 4, wherein the torsion spring retention pin is installed on the air blower body such that the torsion spring is retained on the torsion spring retention pin.

6. The air blower according to claim 5, wherein when needed, the air blower is installed onto the barbeque smoker side wall by compressing the two arms of the torsion spring to let the two arms to pass through the air inlet opening of the barbeque smoker, and release the two arms of the torsion spring inside of the air inlet opening of the barbeque smoker, such that the two arms expand and pressing on the side edge of the air inlet opening of the barbeque smoker and the resilient force of the two arms of the torsion spring keeps the air blower in place.

7. The air blower according to claim 6, wherein the torsion spring is in the shape of a “V” with two arms bent inward such that the two arms are approximately parallel for the outer half of the two arms.

8. The air blower according to claim 6, wherein the torsion spring is in the shape of a

9. A method of installing an air blower on a barbeque smoker having a side wall, and an air inlet opening with side edge, comprising the steps of:
(a) providing an air blower, wherein the air blower comprises:
(i) a rotary air blowing fan having an air outlet;
(ii) an air blower body having a first end and a second end with an air passage inside the air blower body between the first end and the second end;
(iii) a front installation panel;
(iv) a torsion spring having two arms with a round ring on each of the two arms;
(v) a torsion spring retention pin; and
(vi) a shutter;
(b) installing the torsion spring onto the torsion spring retention pin on the air blower body; and
(c) installing the air blower onto the barbeque smoker through the air inlet opening of the barbeque smoker.

10. The method of claim 9, wherein the air blower further comprises a shutter retention pin to hold the shutter in place.

11. The method of claim 10, wherein the air blower is installed onto the side wall of the barbeque smoker with the front installation panel of air blower covering the air inlet opening and the air passage passing through the air inlet opening of the barbeque smoker.

12. The method of claim 11, wherein the rotary air blowing fan is installed on the second end of the air blower body with the air outlet covering the air passage of the air blower body.

13. The method of claim 12, wherein the torsion spring retention pin is installed on the air blower body such that the torsion spring is retained on the torsion spring retention pin.

14. The method of claim 13, wherein the step of installing the air blower onto the barbeque smoker through the air inlet opening of the barbeque smoker further comprises the steps of:
(a) compressing the two arms of the torsion spring;
(b) passing the two compressed arms of the torsion spring through the air inlet opening of the barbeque smoker; and
(c) release the two arms of the torsion spring inside of the air inlet opening of the barbeque smoker, such that the two arms expand and pressing on the side edge of the air inlet opening of the barbeque smoker and the resilient force of the two arms of the torsion spring keep the air blower in place.

15. The method of claim 14, wherein the torsion spring is in the shape of a “V” with two arms bent inward such that the two arms are approximately parallel for the outer half of the two arms.

16. The method of claim 14, wherein the torsion spring is in the shape of a “V”.

17. A method of uninstalling an air blower from a barbeque smoker having a side wall, and an air inlet opening with side edge, comprising the step of removing the air blower by pulling the air blower out of the air inlet opening of the barbeque smoker.
